(19) United States
(12) Patent Application Publication
(10) Pub. No.: US 2025/0242522 A1
(43) Pub. Date: Jul. 31, 2025

(54) GRANULAR FERTILIZER COMPOSITIONS AND METHODS OF MANUFACTURING THEREOF

(71) Applicant: V6 AGRONOMY INC., North Augusta (CA)

(72) Inventors: Ryan Michael Thomas BROPHY, North Augusta (CA); Paul Vincent MCNEELY, Metcalfe (CA)

(73) Assignee: V6 AGRONOMY INC., North Augusta, ON (CA)

(21) Appl. No.: 18/423,947

(22) Filed: Jan. 26, 2024

(51) Int. Cl. B29B 9/12; B29B 9/16; C05C 9/00; C05G 5/12; C05G 5/30

(52) U.S. Cl. CPC B29B 9/12; B29B 9/16; C05C 9/00; C05G 5/12; C05G 5/30

(57) ABSTRACT

The present disclosure provides granular fertilizer compositions and methods of manufacturing thereof. The method for manufacturing the granular fertilizer comprises a declining weight measurement process, a mixing process, a compaction process, and a sorting and cleaning process to produce the granular fertilizer. The granular fertilizer composition may be comprised of urea, metabasalt, and a humic substance. The granular fertilizer composition may alternatively comprise metabasalt, biochar, and a humic substance. The present disclosure also provides a compound fertilizer composition comprising metabasalt at a preferred percentage by weight.

### FIELD

The present disclosure is generally directed to granulated fertilizers for use in agronomic applications. Specifically, the present disclosure is directed to granular fertilizer compositions and methods of manufacturing the same.

### BACKGROUND

Urea is commonly used in crop production because it is readily available and can be obtained at a relatively low cost. However, conventional urea fertilizers have many deficiencies, such as lacking bulk density and crush strength, having excessive hygroscopicity, exhibiting insufficient plant uptake, and lacking the ability to sufficiently increase soil health.

Conventional methods of manufacturing urea fertilizers are also deficient. The methods are wasteful and do not make efficient use of raw materials. Some methods of the prior art utilize pan granulation to produce granules. Pan granulation simply agglomerates a subject product with water over a rotating pan. The resulting spherical granules have insufficient crush strength.

There is therefore a need for a fertilizer and a method of manufacturing thereof that addresses the aforementioned deficiencies.

### SUMMARY

In an aspect, the present disclosure provides a method for manufacturing a granular fertilizer, the method comprising: loading a plurality of materials into a declining weight system, the declining weight system to meter the plurality of materials into a predetermined ratio; combining the plurality of materials in a mixing system to create a mixed composition; loading the mixed composition into a compaction system, the compaction system compressing the mixed composition into granular materials; and, sorting and cleaning the granular materials to produce the granular fertilizer.

In another aspect, the present disclosure provides a granular fertilizer composition comprising: metabasalt having micro elements, the metabasalt to provide a remineralization effect to a soil; a humic substance combined with the metabasalt to increase nutrient availability of the granular fertilizer and reduce nitrous oxide emissions; and, urea nitrogen.

### BRIEF DESCRIPTION OF THE DRAWINGS

The following figures serve to illustrate various embodiments of features of the disclosure. The figures are illustrative and are not intended to be limiting.

FIG. 1 is a schematic diagram of an overview of a system for use in a method of manufacturing a granular fertilizer, according to an embodiment of the present disclosure;

FIG. 2 is a schematic diagram of a declining weight measurement process of the system of FIG. 1, according to an embodiment of the present disclosure;

FIG. 3 is a schematic diagram of a mixing process of the system of FIG. 1, according to an embodiment of the present disclosure;

FIG. 4 is a schematic diagram of a compaction process of the system of FIG. 1, according to an embodiment of the present disclosure; and,

FIG. 5 is a schematic diagram of a sorting and cleaning process of the system of FIG. 1, according to an embodiment of the present disclosure.

### DETAILED DESCRIPTION

The following embodiments are merely illustrative and are not intended to be limiting. It will be appreciated that various modifications and/or alterations to the embodiments described herein may be made without departing from the disclosure and any modifications and/or alterations are within the scope of the contemplated disclosure.

The present disclosure provides a method for manufacturing a granular fertilizer. According to an embodiment of the present disclosure, the method generally comprises a declining weight measurement process that combines at least two raw materials in accordance with a fertilizer formulation ratio and that resizes the at least two raw materials; a mixing process that mixes the at least two raw materials to produce a composite blend; a compaction process that compacts the composite blend to produce a granular material; and, a sorting and cleaning process that sorts and cleans the granular material to produce the fertilizer, the fertilizer being a generally uniform granular product.

According to an embodiment of the present disclosure, the at least two raw materials are selected from urea, metabasalt, biochar and a humic substance. In a preferred embodiment, the method may comprise combining at least urea, metabasalt, and the humic substance. In another preferred embodiment, the method may comprise combining metabasalt, biochar, and the humic substance. In another preferred embodiment, the method may comprise combining metabasalt with other raw materials to manufacture a compound fertilizer. In another preferred embodiment, the compound fertilizer may comprise metabasalt at 5% to 25% by weight. In another preferred embodiment, the compound fertilizer may comprise macronutrients such as nitrogen, phosphate, and potassium, secondary nutrients such as sulphur, calcium, and magnesium, and micronutrients such as manganese, iron, zinc, molybdenum, copper, boron, and silicon derived from the metabasalt.

According to an embodiment of the present disclosure, granular urea, prilled urea, or a combination of granular and prilled urea may be used as one of the at least two raw materials.

According to an embodiment of the present disclosure, metabasalt comprising magnesium silicate rock fines may be used as one of the at least two raw materials.

According to an embodiment of the present disclosure, humic acid may be used as one of the at least two raw materials.

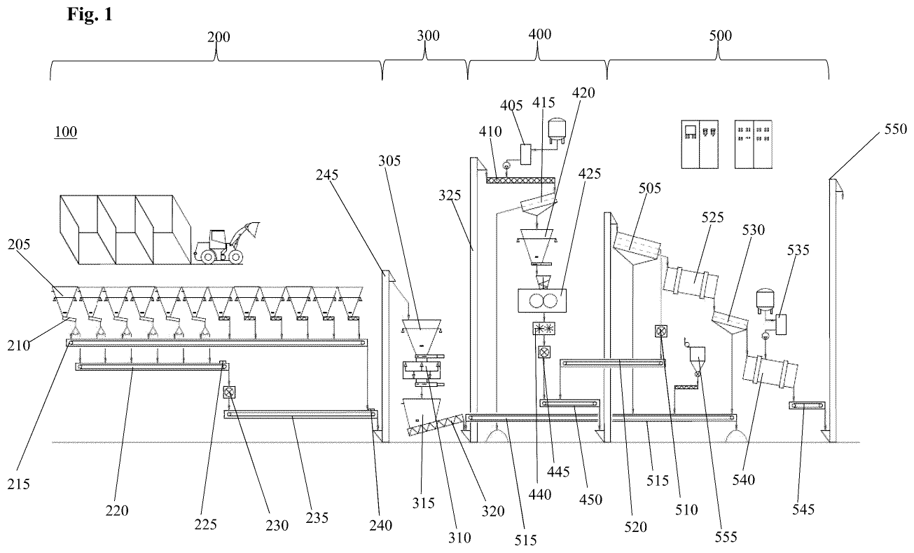

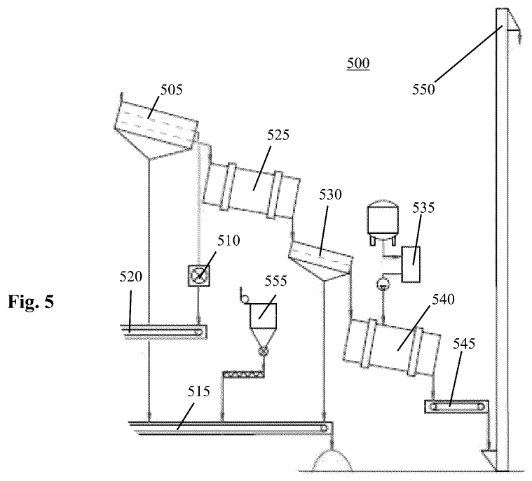

With reference to FIGS. 1, 2, 3, 4 and 5, and according to an embodiment of the present disclosure, a schematic representation of a system 100 used for manufacturing a granular fertilizer is shown. In a preferred embodiment, the method for manufacturing the granular fertilizer generally comprises a declining weight measurement step 200, a mixing step 300, a compaction step 400, and a sorting and cleaning step 500.

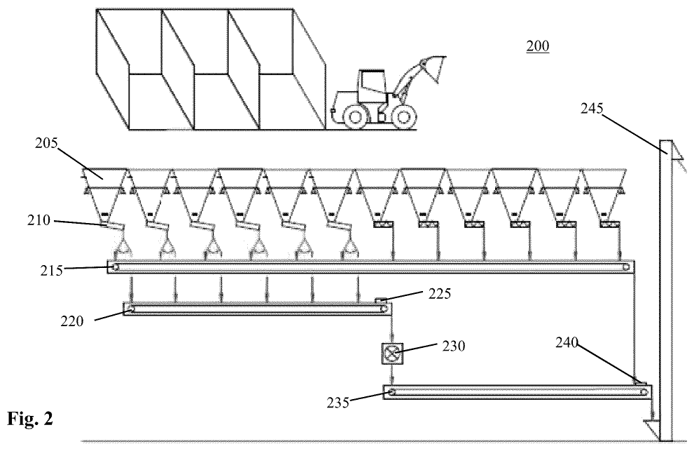

More specifically, with reference to FIGS. 1 and 2, the present system 100 describes a method of manufacturing that combines at least two raw materials through a declining weight measurement process 200 in accordance with a desired fertilizer formulation ratio. In a first step of the declining weight measurement process 200, the system 100 loads at least two raw materials (not shown) into separate hoppers 205. Although a plurality of hoppers 205 are shown, a worker skilled in the art would appreciate that at least two hoppers 205 are preferred in the present system 100. The two raw materials (not shown) are transferred from the hoppers 205 to feeders 210, each hopper 205 being fitted with a feeder 210. The feeders 210 meter the raw materials (not shown) onto a conveyor belt 215. The amount of raw material that is metered from each of the feeders 210 is determined in accordance with a desired fertilizer formulation ratio.

The first conveyor belt 215 generally separates the metered raw materials into two groups: a group of oversized raw materials (not shown) and a group of sorted raw materials (not shown). The group of sorted raw materials (not shown) is transferred to second conveyor belt 235. The group of oversized raw materials (not shown) is placed on an oversize belt conveyor 220 that in turn transfers the group of oversized raw materials to a magnetic separator 225 that removes foreign objects (not shown). Foreign objects may include wear components such as bolts, washers, nuts, screws, and steel fragments. Foreign objects may also include handling equipment fragments left over from delivery of the raw materials, such as conveyor, load-out equipment, truck components, and other components that may have been shed during storage and delivery of the raw materials. The oversized raw materials (not shown) are then transferred to a hammer mill 230 for preliminary resizing. The hammer mill 230 pulverizes the group of oversized raw materials to form a group of preliminarily resized raw materials (not shown) that are transferred to the second conveyor belt 235. The second conveyor belt 235 transfers the sorted raw materials and the preliminarily resized raw materials to a second magnetic separator 240 that further removes foreign objects. The second conveyor belt 235 then transports the sorted raw materials (not shown) and preliminarily resized raw materials (not shown) to a first bucket elevator 245 that then elevates the materials for subsequent mixing.

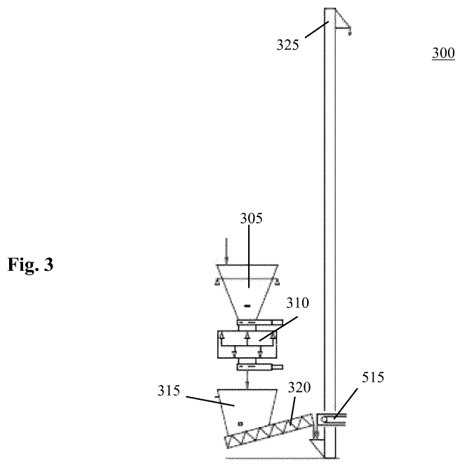

Referring to FIG. 3, a mixing process 300 starts by transferring the sorted raw materials (not shown) and preliminarily resized raw materials (not shown) from the previous declining weight measurement step 200 to a buffer tank 305 for premixing. The buffer tank 305 combines and premixes the sorted raw materials and preliminarily resized raw materials into what is termed “premixed materials”. The premixed materials (not shown) are then mixed in a batch mixer 310 to produce a composite blend (not shown). The composite blend (not shown) is then transferred to a second buffer tank 315 and then placed on a transfer auger 320. The transfer auger 320 transports the composite blend to a second bucket elevator 325 for subsequent compaction.

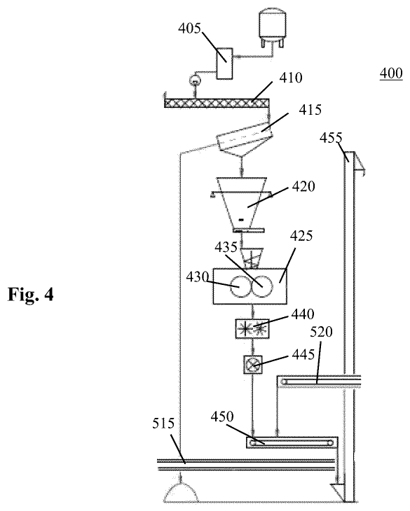

Referring to FIG. 4, a compaction process 400 starts by adding water (not shown) to the composite blend (not shown) with a water spraying system 405 that adds water to the composite blend. A double mixing screw 410 then mixes moisture (not shown) into the composite blend (not shown). The composite blend (not shown) is transferred to a protection screen 415 where undesired objects (not shown) are removed from the composite blend. The undesired objects may include the foreign objects mentioned above, along with clumps and contaminants. A second hopper 420 pre-presses the composite blend (not shown) into a compactor 425 that comprises first and second rollers 430, 435. The first and second rollers 430, 435 compress the composite blend (not shown) with extreme mechanical force to form a flake (not shown). In one embodiment, extreme mechanical force is up to 120 KN/cm² or 1706 psi. The flake (not shown) is broken with a flake breaker 440 to form flake pieces (not shown) that are in turn broken with a second hammer mill 445 to produce a granular material (not shown). A third belt conveyor 450 transports the granular material (not shown) to a third bucket elevator 455 for subsequent sorting and cleaning.

The present compaction process 400 provides several advantages over conventional liquid and slurry processes. The compaction process 400 allows the fertilizer granules to have increased bulk density, reduced hygroscopicity, and increased crush strength. Conventional liquid and slurry processes, such as nitrophosphoric to drum granulation and accretion processes, rely on natural gas for granulation. Meanwhile, the compaction process 400 eliminates the need for natural gas. The compaction process 400 mitigates challenges encountered with material compatibility that are often observed in liquid processes. Additionally, the compaction process 400 yields less material waste and shrinkage and permits the production of smaller batch sizes. In one embodiment of the present disclosure, the present compaction process 400 does not require water.

With reference to FIGS. 3, 4, and 5, the sorting and cleaning process 500 begins by transferring the granular material (not shown) to a production screen 505 that separates the granular material into fines (not shown), oversized granules (not shown), and optimally sized granules (not shown). In an embodiment, the average diameter of the optimally sized granules is 2 to 4 millimeters. In yet another embodiment, the average diameter of the optimally sized granules is 3 millimeters or 300 SGN (size guide number). Fines (not shown) are placed on a fourth belt conveyor 515 that transports the fines to the second bucket elevator 325 for re-entry into the compaction process 400. As such, the fines do not become waste, and are instead reused, thereby increasing the efficiency of the system (not shown). A third hammer mill 510 resizes the oversized granules (not shown) to form resized granular material (not shown) that is placed on a fifth belt conveyor 520. The resized granular material (not shown) is then transported to the third belt conveyor 450 that in turn transfers the resized granular material (not shown) to the third bucket elevator 455 for re-entry into the sorting and cleaning process 500.

Optimally sized granules (not shown) are placed in a polishing drum 525 where sharp edges are removed to form polished granules (not shown) having a generally uniform spherical shape. Fines and dust (not shown) that are produced from the polishing step are removed using a final screen 530. The fines and dust that are captured by final screen 530 are transferred to the fourth belt conveyor 515 that in turn transfers the fines and dust (not shown) to the second bucket elevator 325. The fines and dust (not shown) are then re-entered into the compaction process 400. As such, the fines and dust do not become waste, and are instead reused, thereby increasing the efficiency of the present system (not shown). The polished granules (not shown) are sent through a coating spraying system 535 to add color to the polished granules. After the polished granules are colored, they are transferred to a drum 540 that suppresses dust. Upon completion of the sorting and cleaning process 500, a uniform granular product (not shown) is formed. The uniform granular product (not shown) is placed on a sixth belt conveyor 545 that in turn transports the finished product (not shown) to a fourth bucket elevator 550 that will send the uniform granular product into storage.

Dust (not shown) made throughout the manufacturing process (not shown) is captured by dedusting system 555. The dust (not shown) is then transferred to the fourth belt conveyor 515, and then transported to the second bucket elevator 325 for re-entry into the compaction process 400. As such, the dust does not become waste, and is instead reused, thereby increasing the efficiency of the system (not shown).

The present disclosure provides a granular fertilizer composition that has been shown to have both physical and agronomic advantages over conventional fertilizers. In one embodiment of the present disclosure, the granular fertilizer composition comprises urea, metabasalt, and a humic substance. In another embodiment of the present disclosure, the granular fertilizer composition comprises 85% urea by weight, 10% metabasalt by weight, and 5% humic substance by weight. This particular weight percentage of urea, metabasalt, and humic substance helps maintain a total nitrogen value over 39% in a conventional 46% analysis of urea. The composition may contain prilled urea, granular urea, or both of the aforementioned forms of urea. The metabasalt may comprise magnesium silicate rock fines. The humic substance may be humic acid and may be pulverized. In one embodiment, the metabasalt and humic substance may form a coating around the urea.

The present granular fertilizer composition preferably provides increased bulk density, increased crush strength, and decreased hygroscopicity over conventional granular urea. Regarding increased bulk density, the present granular fertilizer composition has a preferable bulk density range of 52-54 lbs/cu ft (833 kg-881 kg per cubic meter), as compared to the bulk density of conventional granular urea of 44-48 lbs/cu ft (705 kg-769/cubic meter). The increased bulk density has several advantages, including reduced storage space, reduced equipment fills required at application time, reduced transportation costs, superior spreading characteristics during broadcast application (such as greater trajectory), and less particle segregation when blended with other granular products of greater bulk density. Regarding increased crush strength, the present granular fertilizer composition has a preferable crush strength of over 5 kg per granule as compared to 1.2-3.2 kg per granule in conventional granular urea.

As such, the present granular fertilizer composition produces less dust and fines during handling. The present granular fertilizer may also be more resilient during broadcast application, and may incur less damage when applied, for example, with a spinner spreader. Regarding decreased hygroscopicity, the present granular fertilizer composition has improved storability, causes less corrosion when in contact with metal surfaces, has increased compatibility and can be better blended with other granular products, and causes less condensation in work areas, thereby reducing wet or slimy floors that is typical during handling of conventional granular urea.

The present granular fertilizer composition provides agronomic benefits to both plant uptake and overall soil health. Additionally, the present granular fertilizer does not comprise N-butyl triphosphoric triamide and dicyandiamide that are known carcinogens. In this regard, individuals handling the present granular fertilizer compositions reduce their exposure to carcinogens.

The present granular fertilizer composition provides at least the following agronomic benefits: increased soil microbial health as compared to straight urea and urea treated with chemical stabilizers, increased nutrient availability due to the ability of humic substances to chelate nutrients combined with the pH buffering effect of metabasalt and a humic substance, increased plant health from the provision of silicon nutrition, increased plant health from silicon's capacity to mitigate abiotic stresses brought on for instance, by drought or flooding, soil remineralization effect due to the provision of micro elements provided by the metabasalt, carbon dioxide removal via the carbonation of atmospheric carbon dioxide as a process of enhanced rock weathering, nitrous oxide emission reduction by virtue of the metabasalt and humic substance elements of the present composition, and greater nitrogen availability to the plant due to reduced nitrogen loss from volatilization, leaching, and denitrification.

In another embodiment of the present disclosure, a granular fertilizer composition comprising metabasalt, biochar, and a humic substance is provided. The humic substance may be humic acid. Preferably, the granular fertilizer composition comprises 65% metabasalt by weight, 30% biochar by weight, and 5% humic acid by weight. A composition having the aforementioned weight ratio of metabasalt, biochar, and humic acid has advantages. The composition may be readily used by the bulk blending retail sector as a value-added filler. The composition may also be used as is by growers through existing application equipment.

In another embodiment of the present disclosure, a compound fertilizer composition comprising 5% to 25% metabasalt by weight is provided. In another preferred embodiment, the compound fertilizer may comprise macronutrients such as nitrogen, phosphate, and potassium, secondary nutrients such as sulphur, calcium, and magnesium, and micronutrients such as manganese, iron, zinc, molybdenum, copper, boron, and silicon derived from the metabasalt.

Many modifications of the embodiments described herein as well as other embodiments may be evident to a person skilled in the art having the benefit of the teachings presented in the foregoing description and associated drawings. It is understood that these modifications and additional embodiments are captured within the scope of the contemplated disclosure which is not to be limited to the specific embodiment disclosed.

1. A method for manufacturing a granular fertilizer, the method comprising:
loading a plurality of materials into a declining weight system, the declining weight system to meter the plurality of materials into a predetermined ratio;
combining the plurality of materials in a mixing system to create a mixed composition;
loading the mixed composition into a compaction system, the compaction system compressing the mixed composition into granular materials; and,
sorting and cleaning the granular materials to produce the granular fertilizer.

2. The method of claim 1 wherein the declining weight system is further comprised of a vibrating feeder to meter the plurality of materials into the predetermined ratio.

3. The method of claim 1 herein the declining weight system is further comprised of:
an oversize system to sort out oversized materials from the plurality of materials;
a magnetic separator to remove foreign objects from the plurality of materials; and,
a first hammer mill for pulverizing the oversized materials sorted out by the oversize system.

4. The method of claim 1 wherein the compaction system is further comprised of a protection screen for removing undesired objects from the mixed composition.

5. The method of claim 1 wherein the compaction system is further comprised of a compactor, the compactor to compress the mixed composition into primary flakes.

6. The method of claim 5 wherein the compactor is further comprised of two rollers.

7. The method of claim 1 wherein the compaction system is further comprised of:
a breaker to break down the primary flakes into smaller flakes; and,
a second hammer mill to split the smaller flakes into the granular materials.

8. The method of claim 1 wherein the sorting and cleaning further comprises:
a production screen to remove fines and large materials from the granular materials and re-cycle the fines and the large materials to reduce waste in the manufacture of the granular fertilizer; and,
a third hammer mill configured to receive the large materials, further compact the large materials and return the compacted large materials to the production screen,
wherein the production screen returns the fines to the compaction system, the compaction system adding the fines to the mixed composition.

9. The method of claim 1 wherein the sorting and cleaning further comprises a drum to remove sharp edges from the granular materials and render the granular materials into a generally spherical shape.

10. The method of claim 1 wherein the sorting and cleaning further comprises a dedusting system to capture loose dust in the granular materials and re-cycle the loose dust to the compaction system to minimize waste.

11. The method of claim 1 further comprising hydrating the mixed composition to form a hydrated mixed composition, the compaction system compressing the hydrated mixed composition into the granular materials.

12. A granular fertilizer composition comprising:
metabasalt having micro elements, the metabasalt to provide a remineralization effect to a soil;
a humic substance combined with the metabasalt to increase nutrient availability of the granular fertilizer and reduce nitrous oxide emissions; and,
urea nitrogen.

13. The granular fertilizer of claim 12 comprised of between 5% and 25% of the metabasalt by weight.

14. The granular fertilizer of claim 12 comprised of 85% of the urea nitrogen by weight, 10% of the metabasalt by weight, and 5% of the humic substance by weight.

15. The granular fertilizer of claim 12 wherein the urea nitrogen is at least one of: prilled urea and granular urea.

16. The granular fertilizer of claim 12 wherein the metabasalt is further comprised of magnesium silicate rock fines.

17. The granular fertilizer of claim 12 wherein the humic substance is one of: a humic acid and a pulverized humic substance.

18. The granular fertilizer of claim 12 wherein the metabasalt and the humic substance form a coating around the urea nitrogen.
